(19) United States
(12) Patent Application Publication
(10) Pub. No.: US 2022/0119289 A1
(43) Pub. Date: Apr. 21, 2022

(54) PROCESS FOR RECOVERING PHOSPHORUS

(71) Applicant: CNP CYCLES GMBH, Karlstein am Main (DE)

(72) Inventors: Thomas KLAMP, Hanau (DE); Markus GERLACH, Hanau (DE)

(73) Assignee: CNP CYCLES GMBH, Karlstein am Main (DE)

(21) Appl. No.: 17/426,855

(22) PCT Filed: Feb. 3, 2020
(86) PCT No.: PCT/EP2020/052592

§ 371 Date: Jul. 29, 2021

(30) Foreign Application Priority Data
Feb. 4, 2019 (DE) 10 2019 102 700.4

(51) Int. Cl. C02F 1/52; C01B 25/32; C02F 9/00; C02F 11/04; C02F 11/12; C02F 1/38

(52) U.S. Cl. CPC C02F 1/5245; C01B 25/32; C02F 9/00; C02F 2101/105; C02F 11/12; C02F 1/385; C02F 11/04

(57) ABSTRACT

The invention relates to a method for recovering phosphorus from sludge in sewage plants, wherein: the sludge is pre-acidified under anaerobic process conditions and the pH value is then increased to a pH value <7 by adding at least one alkaline calcium-containing chemical; brushite crystals are formed by calcium ions of the chemical and are precipitated, and deposited brushite crystals are removed; and the phosphorus-reduced sludge is then supplied to a digestion process.

The invention relates to a method for recovering phosphorus from sludge in sewage plants, wherein the sludge is pre-acidified under anaerobic process conditions and the pH value is then increased to a pH value <7 by adding at least one alkaline calcium-containing chemical, brushite crystals are formed by calcium ions of the chemical and are precipitated, and deposited brushite crystals are removed and the phosphorus-reduced sludge is then supplied to a digestion process.

Phosphorus is a vital substance for organisms, which occurs in bound form in the earth's crust and is not substitutable, at least in flora and fauna or living organisms. Phosphorus is required, for example, in the production of foodstuffs, in the growth of plants as a fertilizer, and in industry such as in iron and steel production. Phosphorus is utilized extensively in the agricultural sector in particular.

Even if the natural resources of phosphorus do not appear to have been depleted for a number of decades, extensive efforts are underway to recover phosphorus. The recovery of phosphorus from wastewater is of particular importance.

There are a large number of methods to recover phosphorus, for example from sludge water by adsorption, precipitation, crystallization or by using pellets or from digested sludge by means of or without leaching, or from ash by thermal treatment.

DE 101 12 934 B4 discloses a method in which digested sludge is aerated in order to increase the pH value by CO₂ stripping in order to precipitate MAP with the simultaneous addition of magnesium chloride.

The same principle is used according to EP 2 028 161 B1. In this case, a reaction vessel is used in which sludge is circulated. Precipitating MAP crystals are deposited in a funnel-shaped bottom region in order to then be withdrawn via a removal device that can be shut off on both sides.

In order to biologically remove phosphates from wastewater without the addition of precipitants, wastewater is first subjected to anaerobic and then aerobic environmental conditions. In the anaerobic phase, dissolved phosphate is released and in the subsequent aerobic phase it is increasingly taken up again in the form of polyphosphates. Here, more phosphates are incorporated than were released in the anaerobic phase. A biological phosphorus elimination in this regard (in short: Bio-P) is carried out in wastewater treatment plants, with activation with further biological P elimination taking place between mechanical pretreatment/primary clarification and secondary clarification.

WO 2018/067631 A1 describes a method for recovering phosphorus, in which the liquid phase of sludge of a phosphorus recovery system is supplied, in which the pH value is adjusted from about 5.5 to a value between 6 and 7 by adding calcium-containing chemicals. Brushite (CaHPO₄.2H₂O) precipitates in the process.

Since phosphorus is only recovered from the separable liquid phase of the sludge, a considerable proportion of phosphorus is lost.

A generic method can be found in US 2013/099420 A1.

It is the object of the present invention to recover phosphorus optimally, i.e. in large amounts, from sewage sludge.

To achieve the object, the invention proposes a method for recovering phosphorus from sludge such as sewage sludge, wherein sludge is pre-acidified under anaerobic process conditions and the pH value is then increased to a pH value <7, preferably to about 6.5, by adding at least one alkaline calcium-containing chemical, brushite crystals are precipitated, and deposited brushite crystals are removed and the phosphorus-reduced sludge is then supplied to a digestion process, and characterized in that the sludge is dewatered after the digestion process and at least part of the filtrate obtained in this way is supplied to the pre-acidified sewage sludge.

According to the invention, a method for recovering phosphorus from sludge is proposed, which is applied upstream of the sludge digestion plant. The phosphorus recovery system can be designed in one or more stages. Ortho-phosphate is precipitated with calcium and thus converted into a stable, solid form that can be separated from the sewage sludge.

The sludge is primary sludge, excess sludge or a mixture of these two sludges, wherein delivered organic substrates or sludges or sewage sludges delivered from other waste water plants can be utilized also.

Because the phosphorus recovery is carried out before the sludge is digested, the uncontrolled precipitation, the so-called “wild” precipitation in the digestion process, is counteracted. Because the dissolved orthophosphate is precipitated directly from the sludge as a whole, a high phosphate separation rate or recycling rate can be achieved.

Before the phosphate is precipitated, provision is made that the sludge is pre-acidified either cold or warm, i.e. psychrophilic, psychrotolerant, mesophilic or thermophilic, wherein two process steps are carried out, namely the enzymatically induced hydrolysis of high molecular weight organic substances and the fermentation down to low molecular weight organic acids. To this end, the pre-acidification is carried out under anaerobic process conditions with the result that the pH value is reduced by the organic acids generated, and a large part of the phosphorus bound or incorporated in the sludge is largely brought into true solution as orthophosphate under the corresponding conditions.

The pre-acidification can be carried out over a period of between 1 and 7 days at a temperature between 5° C. and 75° C. Pre-acidification can be carried out in a manner that is psychrophilic at a temperature optimally between 12° C. and 20° C., psychrotolerant at a temperature optimally between 20° C. and 30° C., mesophilic at a temperature optimally between 30° C. and 40° C. or thermophilic at a temperature optimally between 55° C. and 75° C. The length of time the sludge is pre-acidified is determined depending on the temperature.

To increase the redissolution of the phosphate, provision can be made according to the invention that the sludge—only excess sludge or together with externally delivered substrates and/or together with primary sludge—is disintegrated before the pre-acidification. In this case, the disintegration can take place mechanically, thermally, thermo-chemically, thermally with pressure or by the action of ultrasound. The disintegration destroys cell structures, so that, inter alia, phosphates bound or incorporated in the biomass also go into true solution and are therefore accessible for phosphorus recovery.

In order to precipitate the brushite, the pre-acidified sewage sludge is supplied to a phosphorus recovery system regardless of whether it has previously been disintegrated.

Prior to this, according to the invention, filtrate obtained from the sludge removed from the digestion and then dewatered is at least partially returned to the pre-acidified sludge, whereby the pH value is raised in order to be able to carry out the subsequent precipitation in the phosphorus recovery system optimally.

The return of filtrate also has the advantage that the viscosity of the pre-acidified sludge is reduced and thus the separation of crystals from the sludge can be improved; because a low viscosity facilitates the separation of the crystals from the sludge due to differences in density, thus benefitting the discharge of the crystals.

In order to enable optimal phosphorus recovery, which is extensive in terms of quantity, the pre-acidified sewage sludge can be supplied with redissolved orthophosphate, which may be released in downstream processes in the phosphorus recovery system, through the return of filtrate from digested sludge dewatering, thereby optimizing phosphorus recovery.

To precipitate the brushite, the phosphorus recovery system is supplied with the alkaline calcium-containing chemical, in particular calcium solution such as calcium hydroxide, in order to set a pH value of <7, in particular between 6.3 and 6.7, preferably of about 6.5, in the phosphorus recovery system.

In the phosphorus recovery system, the sewage sludge is supplied to a reaction vessel in which there may be an aerobic environment and in which the sludge is circulated with mechanical or hydrodynamic force and/or supported by aeration.

There is also the option of carrying out a two-step process for separating brushite, i.e., that the recovery is carried out in a phosphorus recovery system having a first and a second reaction vessel. For this purpose, a calcium-containing chemical is added to the sludge present in the first reaction vessel. The sludge from the first reaction vessel is supplied to the second reaction vessel via a line, in which second reaction vessel there is an anaerobic environment for phosphate redissolution. The brushite crystallized in the second reaction vessel is then returned to the first reaction vessel.

The sludge from the second reaction vessel can optionally be supplied to a separator in order to separate further brushite crystals, which are supplied to the first and/or the second reaction vessel.

Inside the first reaction vessel, at least one mixing system is provided either by aeration or by a stirring unit in order to enable the sewage sludge to be circulated in a cylindrical interior of the first reaction vessel, which is surrounded by a cylindrical exterior region, so that the sludge flows through the cylindrical exterior region towards the bottom region of the reaction vessel.

In order to precipitate the orthophosphate, in particular the alkaline calcium-containing chemical is added to the sludge surface, preferably in the region of the cylindrical exterior region. However, there is also the possibility of adding the calcium-containing chemical directly to the sludge supply to the first reaction vessel.

In order to have sufficient calcium available, it is also possible to supply a pH-neutral calcium-containing chemical, such as calcium chloride, so that the pH value is not changed as a result.

According to the invention, the redissolved orthophosphate is precipitated in a one-stage or two-stage phosphorus recovery system by adding calcium-based chemicals in the form of calcium hydrogen phosphate of the composition CaHPO₄, also called dicalcium phosphate (DCP), or in the form of a dihydrate (CaHPO₄.2H₂O), which is known as brushite. The brushite is separated from the sewage sludge by a separator and removed from the process. There is also the possibility of leaving the brushite stably bound in the solids content of the sewage sludge.

In the case of a single-stage phosphorus recovery system, a reaction vessel can be used which is divided into a cylindrical upper vessel part and a conical or funnel-shaped lower vessel part. In this case, a further cylindrical shaft should be installed in the cylindrical part of the reaction vessel, which divides the reaction vessel part into an interior region and an exterior circular ring-shaped, more precisely, a cylindrical ring-shaped exterior region. The cylindrical shaft installation ends slightly below the sludge level on the one hand and above the transition from the cylindrical region to the funnel-shaped vessel part on the other hand. Consequently, the reaction vessel is divided into three regions, a cylindrical interior region, a cylindrical ring-shaped exterior region and a conical lower region. If the precipitated phosphate is not to be separated from the sludge and removed, the lower funnel-shaped conical part can be dispensed with. In this case, there is also the option of omitting the cylindrical shaft installation.

The sludge present in the reaction vessel is circulated either by a mechanical mixer or by aeration. In this case, the circulation has at least two tasks, that is to say, on the one hand, mixing the sludge or forming a directed flow profile and, on the other hand, classifying the brushite crystals. The circulation is to be designed in such a way in this case that there is an upward flow in the interior and a downward flow in the edge region, which is understandably optimized if there is a cylindrical shaft installation.

The downward flow can also be turned into a vortex-like swirl by means of baffles in the cylindrical exterior region. The energy input to generate the flow also establishes the buoyancy force in the interior region of the cylindrical part. The brushite crystal sizes are classified by the buoyancy force. The larger the crystal structure and thus its weight, the greater the sedimentation rate caused by gravity. Above a certain size and thus a certain weight of the crystals, the buoyancy force is no longer sufficient to carry them along in the vertical upward flow, so that the crystals sediment and deposit in the lower conical region. On the other hand, small crystals, that is to say, those with a low weight, can be entrained in the flow and thus can be circulated until the crystals have grown to a size for them to deposit in the cone due to gravity. A crystal removal system can be attached to the bottom of the cone.

The phosphorus recovery system, i.e. the reaction vessel, should be charged with pre-acidified sludge, preferably diluted with filtrate, in the cylindrical, that is to say, in the upper part of the reaction vessel, preferably onto the sludge surface and away from the drain. The metered addition of the calcium-containing chemical should be carried out accordingly.

The aim of the metered addition of the chemical is to set an excess of calcium and the targeted setting of the pH value in the range of preferably 6.5 for a highly selective brushite precipitation. By the metered addition of an alkaline calcium solution such as calcium hydroxide, the calcium ion concentration in the sludge and the pH value are increased. Preferably, in addition, a pH-neutral calcium-containing chemical, such as, for example, calcium chloride, is added in order to increase the calcium concentration to the desired extent without influencing the pH value.

With a corresponding regulation of the metered addition of alkaline and neutral calcium-containing chemicals, the calcium concentration and the pH value can be set in a targeted manner in order to initiate the desired brushite precipitation in the further time course of crystal formation or the crystal growth.

In the exterior region of the reaction vessel, which is circular in cross section, there is a drainage shaft. Drainage works according to the displacement principle, i.e. when the reactor is charged with sewage sludge, i.e. a sludge/water mixture, sewage sludge is flushed out of the reaction vessel simultaneously and in the same volume proportion. The displacement takes place from the lower region of the cylindrical region of the reaction vessel, that is to say, in the cylindrical ring-shaped exterior region.

Draining sludge/water mixture, that is to say, sludge, flows upwards in the drainage channel over a drainage barrier into the drainage region. The drained sludge, in case of a one-step process, is then preferably passed from the reaction vessel into a subsequent sewage sludge thickening system.

The brushite crystals, which are not entrained in the flow, deposit in the conical region of the reaction vessel adjoining the cylindrical region and slide, due to the slope of the cone, towards the conical tip in order to be able to remove brushite crystals deposited from this region.

If the displaced sludge, that is to say, the sludge/water mixture, is supplied to a sewage sludge thickening system in the one-step process, then, in the two-step process variant, the discharge from the reaction vessel is supplied to a second reaction vessel. The first and second reaction vessels are connected in series, the second reaction vessel likewise having a cylindrical upper part and a conical lower part.

While in the first reaction vessel circulation takes place either by a mechanical agitator or by means of compressed air aeration, only gentle stirring takes place in the second reaction vessel, but no aeration. As a result, the contents of the second reaction vessel, provided that the first reaction vessel is aerated, is placed in anaerobic environmental conditions through continued biological degradation processes with vigorous oxygen consumption. If a stirring unit is used in the first reaction vessel, anaerobic environmental conditions prevail in the entire phosphorus recovery plant.

If bacteria contained in the sewage sludge have taken up more phosphate in parallel to orthophosphate precipitation in the first reaction vessel under aerobic conditions, phosphate redissolution takes place in the second reaction vessel under anaerobic conditions, which can lead to further crystallization or to continued crystal growth of previously formed microcrystals.

The microcrystals newly generated or grown in this way are conveyed back into the first reactor as so-called seed crystals or crystallization nuclei.

Thus, crystal growth takes place in the first reaction vessel in that microcrystals grow into macrocrystals, while microcrystals preferably form in the second reaction vessel in an anaerobic environment due to the redissolution of orthophosphate. Further redissolving of orthophosphates in the second reaction vessel can result from shifts in equilibria in which orthophosphate is chemically or complexly bound and is released during the reduction in the solution according to the law of mass action.

A certain amount of sludge is withdrawn from the lower cone of the second reaction vessel either continuously or at intervals and is circulated into the first reaction vessel via a pump in order to return sediments deposited there to the process. The discharge from the second reaction vessel takes place either also according to the displacement principle via an overflow or via a drain pump. Incoming sludge that is not circulated back into the first reaction vessel, is displaced into the discharge of the two-stage phosphorus recovery system via an overflow or discharged via a pump and diverted to the sewage sludge thickening system.

A hydrocyclone can optionally be used in the outlet of the second reaction vessel. In this way, any brushite crystals in the draining sludge can be separated and conveyed back to the first reaction vessel or second reaction vessel via a separate line and thus supplied back into the phosphorus recovery process.

According to the invention, provision is made that the displaced sludge from the phosphorus recovery system, that is to say, the discharge, is supplied to a sludge thickening system. In this case, thickening can either be carried out gravitationally or mechanically, i.e. by machine. The sludge water, that is to say the clear water obtained from thickening, is then conveyed back to the biological treatment stage of the wastewater treatment plant. Due to the still high proportion of organic acids, a supply directly into the anaerobic tank of the biological treatment stage (Bio-P tank) is preferable.

If not all of the filtrate obtained by dewatering the sludge after digestion is supplied to the pre-acidified sewage sludge, the rest of the filtrate can be supplied to the wastewater treatment together or separately with the clear water, that is to say, the sludge water from the thickening process.

The thickened and treated sewage sludge is then anaerobically stabilized in the digestion plant and then supplied to the sludge dewatering via a sludge buffer vessel set up for the hydraulic decoupling of process stages. The filtrate generated in sludge dewatering is—as explained above—mixed with the pre-acidified sewage sludge either in full flow, that is to say completely, or in partial flow, that is to say only partially.

In this filtration circulation line, a deammonification system can be utilized for biological reduction of the ammonium content in order to reduce the ammonium concentration in the returned filtrate and thus to avoid inhibition by ammonia toxicity effectively and energy-efficiently.

According to a further proposed solution, the invention provides that the brushite crystals are classified and deposited in a reaction vessel, the cross section of which increases gradually or continuously starting from the bottom region, the pre-acidified sewage sludge being supplied to the reaction vessel in its bottom region.

The alkaline calcium-containing substance is supplied to the reaction vessel in the lower region or is added to the sludge supply.

According to the invention, provision is made for a reaction vessel in the form of a fluidized bed reactor using the upflow method for classifying and separating the brushite crystals. The diameter of the reaction vessel—starting from the bottom region—is gradually or continuously expanded, so that the upflow rate decreases accordingly, whereby a classifying with increasing grain sizes towards the bottom is established for the brushite crystals held in suspension, which means that large crystals can be withdrawn from the bottom region of the reaction vessel or reactor.

The alkaline calcium-containing chemical and optional pH-neutral calcium-containing chemical are also added in the lower region of the reaction vessel or directly into or with the sludge supply.

According to the description given above, there is the possibility of integrating a corresponding reaction vessel in a two-stage process, so that it is connected to a second reaction vessel in which anaerobic conditions prevail. Anaerobic conditions can also prevail in the fluidized bed reactor.

Further details, advantages and features of the invention emerge not only from the claims, the features to be taken from them—individually and/or in combination—but also from the following description of the preferred exemplary embodiments to be taken from the drawing.

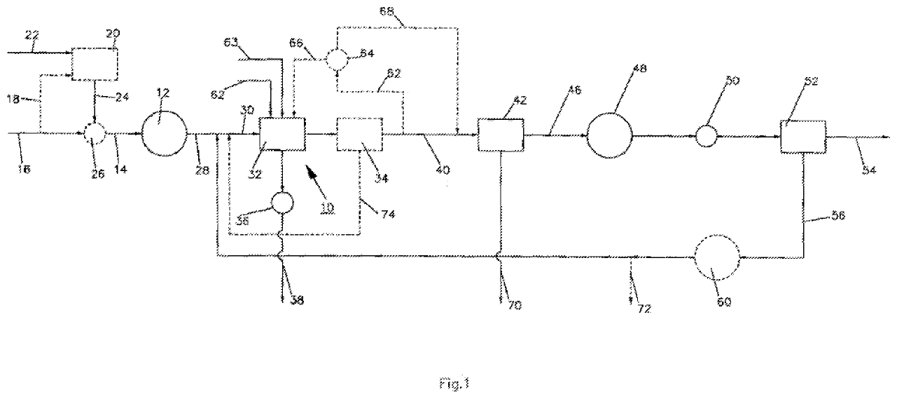

FIG. 1 shows a block diagram of the embedding of the phosphorus recovery system in a sludge treatment system,

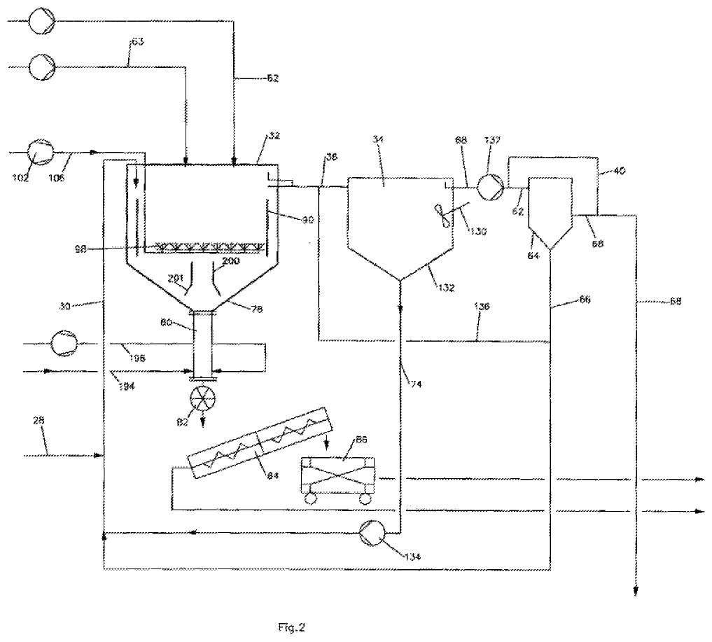

FIG. 2 shows a schematic diagram of an arrangement for the recovery of brushite,

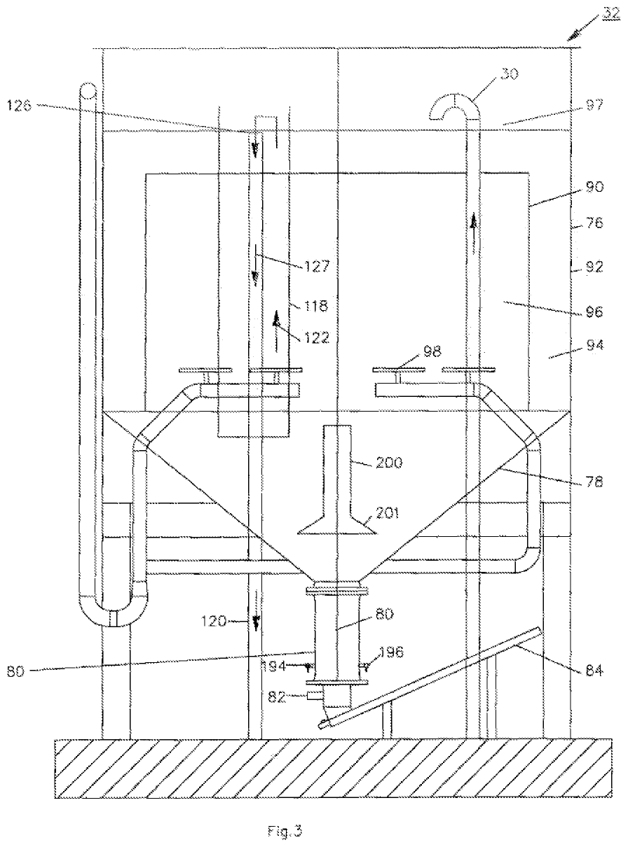

FIG. 3 shows a schematic diagram of a first embodiment of a first reaction vessel, and

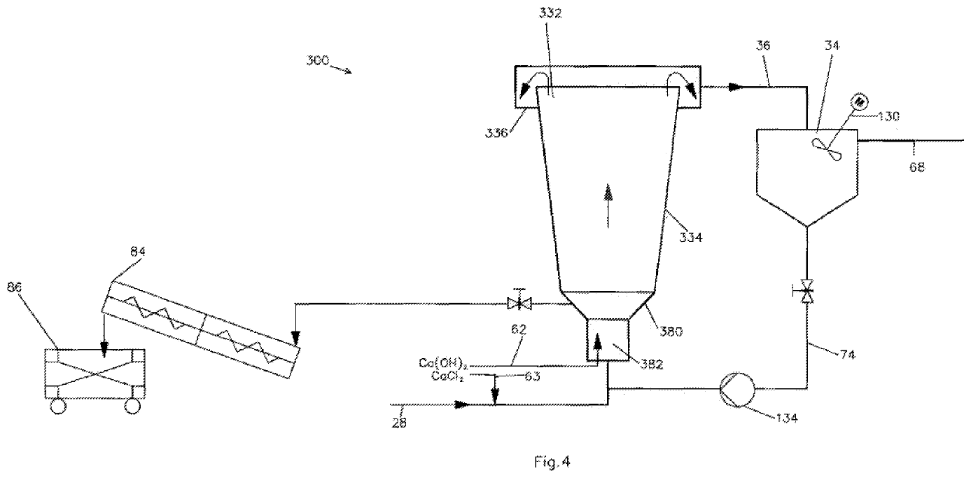

FIG. 4 shows a schematic diagram of a second embodiment of a phosphorus recovery plant.

FIG. 1 illustrates a block diagram of a phosphorus recovery plant with downstream digestion.

Essential components of the phosphorus recovery plant are a single or multi-stage, in particular two-stage, phosphorus recovery system 10 and an upstream pre-acidification system 12, to which sludge such as sewage sludge is supplied via a line 14. The sludge can be a thickened primary sludge supplied via a line 16, i.e. the sludge taken from a primary clarification of a wastewater treatment plant, which can optionally be mixed with excess sludge (line 22), i.e. the sludge taken from a secondary clarification. In addition, organic substrates or sludges such as sewage sludges delivered from external plants can be added.

The primary sludge is supplied in via line 16. If only primary sludge is used, line 16 passes directly into line 14 leading to pre-acidification stage 12. If, on the other hand, the primary sludge is to be disintegrated together with excess sludge, for example, a line 18 branches off line 16, which line 18 can lead to a disintegrator 20, into which a line 22 opens, through which the excess sludge or other sludge or organic substrates are supplied.

Disintegration, in which cell structures are destroyed and, to a corresponding degree, inter alia, phosphates bound or incorporated in the biomass are released and thus become accessible for phosphorus recovery, can take place by means of mechanical, thermal, thermochemical, inductive or pressure-thermal hydrolysis. Disintegration through the action of ultrasound is also possible.

If disintegration takes place, the sludge is supplied to line 14 via a line 24. There may be an upstream sludge mixer 26, in which the sludge from disintegrator 20 is mixed with the sludge flowing in via line 16.

The pre-acidification consists of two process steps, the enzymatically induced hydrolysis of high molecular weight organic substances and the fermentation up to the low molecular weight organic acidification. There is an anaerobic environment during pre-acidification. Under appropriate anaerobic process conditions, the pH value is reduced by the organic acids produced and a large part of the phosphorus bound in the sewage sludge is dissolved to a large extent as orthophosphate under these conditions. The pre-acidification is carried out to such an extent that a pH value between 4 and 5,5, in particular in the range of 5,5, is established. As mentioned, this pH value is important in order to have a large amount of phosphate in true solution.

The sludge can remain in pre-acidification stage 12 for a period of between 1 and 7 days, with process temperatures between 5° C. and 75° C. Pre-acidification can be performed in a manner that is psychrophilic at a temperature in the optimal range between 12° C. and 20° C., psychrotolerant at a temperature in the optimal range between 20° C. and 30° C., mesophilic at a temperature in the optimal range between 30° C. and 40° C., or thermophilic at a temperature in the optimal range between 55° C. and 75° C. The length of time for the pre-acidification of the sewage sludge is determined depending on the temperature.

The pre-acidified sewage sludge is then supplied to the phosphorus recovery system 10, which is designed in one or more stages, in particular in two stages as described above, via a line 28. In the block diagram of FIG. 1, phosphorus recovery system 10 has two reaction vessels 32, 34 which are connected in series. Further details emerge from FIGS. 2 and 3.

Regardless of whether a one-stage or two-stage method is carried out, that is to say, whether there are one or two reaction vessels, an alkaline calcium-containing chemical, such as calcium hydroxide, is supplied (line 62) to the sludge supplied via line 30 in order, on the one hand, to raise the pH value to a value of approx. 6.5 and, on the other hand, to provide sufficient calcium ions to form brushite (CaHPO₄.2H₂O) and to be able to precipitate it in crystal form. In order to have a sufficient calcium ion concentration, a pH-neutral calcium-containing chemical, such as calcium chloride, is also metered in (line 63).

The brushite in crystal form separated from the phosphorus recovery system 10 is collected in a separator 36 in order to then be discharged via an outlet 38. A washing classifier can also be used for sludge/crystal separation.

The sludge removed from phosphorus recovery system 10 is supplied, via a line 40, to a sludge thickening system 42 in which a thickening is carried out either gravitationally or mechanically. The sludge water, that is to say the clear water from thickening, is then supplied to a wastewater treatment plant via a line 70, namely the biological treatment stage, in particular of a wastewater treatment in which a more extensive biological phosphorus elimination (Bio-P) takes place, the clear water preferably being supplied to the anaerobic tank of the biological treatment stage.

The sludge removed from thickening device 42 is supplied, via a line 46, to a sewage sludge digestion system 48 in which the sewage sludge is anaerobically stabilized in order to then be supplied, via a sludge buffer or stacking vessel 50, to sludge dewatering 52, from which the dewatered sludge is removed via a line 54. The filtrate from sludge dewatering system 52 is either partially supplied to the pre-acidified sludge via a line 56 or passed into the wastewater treatment plant (line 72).

A circulation preferably took place so that line 56 is connected to line 28.

Furthermore, a deammonification system 60 can be positioned in line 56 in order to reduce the ammonium content, so that the ammonium concentration in the filtrate is reduced and an inhibition by ammonium toxicity in the phosphorus recovery system is prevented.

The circulation of the filtrate also has the advantage that the pH value of the sludge supplied to the phosphorus recovery system 10 is reduced and the viscosity is lowered as a result of which classifying is made possible in phosphorus recovery system 10.

As can be seen from the block diagram, an alkaline calcium-containing chemical, such as calcium hydroxide, is supplied to phosphorus recovery system 10, specifically to reaction vessel 32, via line 62. A pH-neutral calcium-containing chemical, such as calcium chloride, can be metered in via line 63.

If provision is made for a two-stage process for the separation of brushite crystals, the sludge removed from second reaction vessel 34 can optionally be supplied to a hydrocyclone 64 via a line 62 in order to separate brushite crystals in said hydrocyclone 64, which get to the first reaction vessel 32 via a line 66 or into the second reaction vessel 34 via line 136. The sludge itself is supplied to thickening device 42 via a line 68.

The sludge water removed from the sludge thickening system 42 can be supplied to the wastewater treatment plant via a line 70.

If not all of the filtrate of the filtrate removed from sludge dewatering plant 52 is circulated into the sewage sludge to be supplied to phosphorus recovery system 10, some of the filtrate is supplied to the waste water treatment plant via line 72.

The method for separating the brushite crystals in phosphorus recovery system 10 will be explained in more detail with reference to FIGS. 2 and 3. Here, the two-stage method is explained in FIG. 2, in which first and second reaction vessels 32, 34 are used in accordance with FIG. 1.

There is an aerobic environment in first reaction vessel 32 if the mixing takes place via aeration, and in the second reaction vessel there is an anaerobic environment. First reaction vessel 32 is connected, via line 36, to second reaction vessel 34, which in turn is connected to first reaction vessel 32 via a line 74 for the circulation of brushite crystals or sludge containing crystal nuclei. Line 74 opens into line 28, via which the sewage sludge is supplied to first reaction vessel 32 from pre-acidification device 12.

First reaction vessel 32 consists of an upper cylindrical section 76 and a lower conical or funnel-shaped section 78 in accordance with the schematic diagram according to FIG. 3.

The funnel-shaped lower section 78 transitions into a removal system 80, to be referred to as a separator, in which brushite crystals are collected in order to supply them to a vessel 86 after opening, for example, a rotary valve 82 or an otherwise secured drainage system, e.g., via a dewatering screw 84. The dewatering water accumulating during the transport the screw 84 is discharged via a line. Instead of aforementioned removal system 80, the brushite crystals from the lower section 78 can also be conveyed or routed to a separate sludge/crystal separation system, e.g. into a washing classifier.

In the upper section 76 of the first reaction vessel 32, a partition wall 90 delimiting an annular space in cross section is installed, which runs at a distance from exterior wall 92 of upper section 76, so that between partition wall 90, which forms a hollow cylinder, and exterior wall 92 of first reaction vessel 32 there is an exterior space 94 which is annular in cross section and corresponds to a cylinder ring section. The upper edge of the partition wall 90 runs at a distance from sludge level 97.

On the bottom side, partition wall 90 ends just above the region in which upper section 76 transitions into lower section 78, as can be seen in the drawing.

Inside interior space 96 that is surrounded by partition wall 90, there is an aerator system 98, in particular in the form of membrane aerators, in order to introduce air into interior space 96, which is filled with a sludge/water mixture. Instead of the aeration system, a flow-forming stirring unit can also be used as required.

The mixing has to accomplish several tasks. A directed flow profile of the sludge flowing in reaction vessel 10 with simultaneous mixing is achieved through the energy input. Also, the brushite crystals are classified, as will be explained below.

The mixing of first reaction vessel 32 or the formation of the directed flow in upper part 96 of reaction vessel 32 is generated by the resulting density difference between the non-aerated medium located within exterior space 94 and the aerated medium in interior space 96 as well as through the buoyancy force of the air bubbles emerging from aerator system 98. Due to the difference between the “heavy” medium in exterior annular space 94 and the “lighter” medium present in interior space 96, the sludge or the sludge/water mixture is sucked out of annular space 94 towards the center of the vessel and consequently flows around the lower edge of partition wall 90. Alternatively, the upwardly directed flow in interior space 96 can be generated by an agitator, as a result of which a downwardly directed flow is established in the exterior annular space 94.

In the case of the use of aeration, the sludge is interspersed with air inside interior space 96 in order then to be driven in the direction of buoyancy in interior space 96 in a vertical flow to sludge surface 97. The sludge/water mixture degasses at sludge surface 97 and then flows horizontally above the upper edge of partition wall 90 outwards to annular space 94. The vertical downward movement towards lower section 78 then takes place in exterior unaerated annular space 94. The same flow profile as described above can also be generated using a stirring unit.

The cycle described having an aeration system is driven by the input of energy via the adiabatic compression of air in a compressor and the subsequent polytropic expansion after it has been introduced into the sludge/water mixture. The air is supplied to the membrane aerators 98 by means of a blower 104 via a line 106. These plant components are not required if the energy input takes place mechanically via a stirring unit.

So that brushite crystals can precipitate, the calcium supplied to the sludge is required, which in the exemplary embodiment is supplied in the form of calcium hydroxide, to be precise on the sludge surface 97, preferably via annular space 94.

The energy input also establishes the buoyancy force in interior space 96 of upper section 76 of first reaction vessel 32. Said energy input classifies the precipitating brushite crystal size. The larger the crystal structure, that is to say the higher the weight of the brushite crystals, the greater the sedimentation rate caused by gravity. Above a certain size and thus a weight of the crystals, the buoyancy force in interior space 96 is no longer sufficient to take the crystals along in the vertical upward flow, so that the crystals fall towards lower section 78 and sediment there and accumulate in separator 80. Smaller crystals, on the other hand, are entrained in the flow and are carried along in the process cycle until a size is reached so that they can deposit in the conical or funnel-shaped lower section 78 and thus in separator 80.

The sludge itself, which is supplied to first reaction vessel 32 via line 28, 30 is supplied on sludge level 97 of first reaction vessel 32 in accordance with FIG. 2.

Furthermore, there is the possibility of supplying a defoamer to reduce foam formation on sludge surface 97 via a line 116 or directly into supply line 30. Foam could arise in particular if aeration is provided in the first reaction vessel for mixing.

In the exterior space between partition wall 90 and exterior wall 92, that is to say in annular space 94, there is a drainage shaft 118 which opens into a pipe 120, from which the sludge is supplied to second reaction vessel 34 via line 36.

Drainage from first reaction vessel 32 takes place according to the displacement principle. When first reaction vessel 32 is charged with sludge, sludge is flushed out of first reaction vessel 32 simultaneously and in the same volume proportion.

The displacement takes place from the lower region of upper section 76 from annular space 94 into drainage shaft 118. Draining sludge/water mixture flows upwards in drainage shaft 118—in the drawing corresponding to the direction of arrow 122—in order to then reach the drainage region via a drainage barrier 126, as is illustrated by arrow 127.

The sludge or the sludge/water mixture reaching second reaction vessel 34 via first line 36 is subjected to an anaerobic environment. In order to ensure that this is the case, only gentle mixing (stirrer 130) takes place without aeration. If bacteria contained in the sewage sludge in first reaction vessel 32 under aerobic conditions have taken up more phosphate in parallel to the orthophosphate precipitation, phosphorus redissolution takes place in second reaction vessel 34 under the anaerobic conditions, which leads to further brushite crystal formation or crystal growth.

A predetermined amount of sludge/water mixture is then withdrawn continuously or at intervals, that is to say batchwise, from lower section 132 of second reaction vessel 34, which is also in the form of a cone or funnel and whose upper region should have a cylindrical shape, and is circulated to first reaction vessel 32 via line 74, as previously discussed. For this purpose, a pump 134 is located in second line 74.

Sludge/water mixture which does not circulate into first reaction vessel 32 can be withdrawn from second reaction vessel 34 via a withdrawal pump 137. It is possible to feed the sludge either directly to thickening system 42 via line 40 or, optionally, to route it through separator 64, such as a hydrocyclone, in order to separate any brushite crystals or crystal nuclei that are still present in the sludge, which are then supplied to first reaction vessel 32 via line 66. These are essentially microcrystals.

The brushite crystals separated in first reaction vessel 32 reach separator 80, which starts from the lowest point of lower section 78 of reaction vessel 32.

In order to free the brushite crystals from sludge particles or flakes, the invention makes provision that connections for rinsing water (connection 194) and rinsing air (connection 196) are provided in the lower region of separator 80, whereby the brushite crystals are loosened by the introduced rinsing air and washed by the introduced rinsing water. At the same time, the brushite crystals are classified so that large, that is to say heavy, brushite crystals remain in the lower region of separator 80, while smaller, light brushite crystals and sludge particles and flakes float up and are washed back into first reaction vessel 32. Thus, small brushite crystals are supplied back to the process explained above in first reaction vessel 32, with the result that further growth can take place.

So that the microcrystals and sludge flakes, after loosening by means of the rinsing air, which is supplied to separator 80 via connections 196, and the rinsing water, which is supplied to separator 80 via connections 194, that are flushed out can be supplied back to the previously described process in first reaction vessel 32, provision is made according to the invention that the flushed-out substances are passed through conical lower section 78 of first reaction vessel 32. Without flowing in it, the substances are routed vertically through lower section 78 to upper cylindrical section 76. For this purpose, a tubular guide 200, which is expanded on the separator side (reference numeral 201), is provided, which extends as an extension of separator 80, as can be seen in a self-explanatory manner from the drawing in FIGS. 2 and 3.

Guide 200 with a funnel-shaped widening 201 ensures that the flushed-out substances, that is to say microcrystals and sludge flakes, get directly into the feed zone of the upward flow in the interior space of upper section 76 of first reaction vessel 32, which is surrounded by cylindrical partition wall 90, without being slowed down due the widening of the flow profile in funnel-shaped lower section 78, as a result of which the buoyancy force would be lost.

In other words, guide 200 serves to guide the flushed-out substances from separator 80 directly into interior space 96 of upper section 96, which is surrounded by cylindrical partition wall 90.

With regard to separator 80, it should be noted that, for the function of separating, it can be designed without a closure on the vessel side. However, a closure can be provided which separates separator 80 from the vessel in order to perform maintenance work, for example, at connections 194, 196, for example.

Separator 80 can consist of stainless steel, for example, and optionally have a non-stick coating, in particular on the inside, or can also be made of steel with a non-stick coating on the inside. Typical diameters of a corresponding separator 80 are between 300 mm and 600 mm with an overall length between 400 mm and 1500 mm.

Guide 200 can also consist of stainless steel or steel and optionally be provided with a non-stick coating. Typical diameters should be 300 mm to 600 mm. The length corresponds at most to the height of funnel-shaped or conical-shaped lower section 78 of first reaction vessel 32. Dimensioning and arranging, respectively, must be done in such a way that the brushite crystals can flow to separator 80 unhindered in terms of flow.

If, instead of the separator, a sludge/crystal separation is provided via a washing classifier, guide 200 can be omitted.

The volume of first reaction vessel 32 should correspond to 2 to 10 times the hourly volumetric feed amount to first reaction vessel 32. The same dimensions are to be preferred with regard to second reaction vessel 34.

With regard to the introduction of air via membrane aerators 98, it should be noted that the amount should be 5 to 25 times the hourly volumetric feed amount into first reaction vessel 32.

According to the invention, there should be an anaerobic environment in second reaction vessel 34. Therefore, only gentle mixing takes place. The energy input through stirrer 130 should be 2-20 watts per m³ of reactor volume.

If a one-step process for separating brushite crystals takes place, then one of first reaction vessels 32 described above is used, as is self-explanatory in the schematic diagram in FIG. 3.

FIG. 4 shows a second embodiment of a phosphorus recovery plant, which differs from that described by FIGS. 1-3 in that a fluidized bed reactor 332 is used instead of a loop reactor 32, so that the same reference numerals are used for the same elements. Reference is also expressly made to the disclosure relating to FIGS. 1-3, which also applies to the phosphorus recovery plant according to FIG. 4.

As mentioned, a fluidized bed reactor 332 is used, which, in the drawing, is widened in a conical shape starting from the bottom region (section 334) and has a closed overflow 336 at the top in order to supply the sludge exiting fluidized bed reactor 334 to second reaction vessel 34, as has been explained above.

The sludge enters the overflow 336 according to the displacement principle, i.e. according to the supplied amount of sludge, sludge flows into overflow 336.

The dimensions of the fluidized bed reactor should be specified in such a way that a hydraulic residence time of 0.5-5 hours is set in the reactor.

The flow rate of the sludge in the fluidized bed reactor should be set in such a way that there is a maximum flow rate of 1-5 m/h at the upper end of the fluidized bed reactor (at overflow 336 from reactor 332).

Because the diameter of reactor 332, which can also be referred to as a reaction vessel, widens continuously, the upflow rate of the sludge decreases accordingly, with the result that the brushite crystals that are held in suspension are classified with grain size increasing downwards, allowing withdrawal of large crystals in lower region 380 of reactor 332.

The pre-acidified sludge or sewage sludge is supplied to reactor 332 via line 28 in bottom region 382 of the reactor. The calcium-containing chemical, such as calcium hydroxide, is also supplied in via line 62 in this region 382. It is also possible to add to line 28.

Furthermore, it is illustrated in the drawing that a pH-neutral, calcium-containing chemical such as calcium chloride is added to line 28 carrying the pre-acidified sewage sludge via a line 63.

Otherwise, the functional or procedural aspects of the phosphorus recovery plant according to FIG. 4 correspond to FIGS. 1 and 2, so that the same reference numerals are used.

If reaction vessel 332 continuously widens, there is of course also the possibility of a stepwise enlargement of the cross section in order to reduce the upflow rate in accordance with the teaching according to the invention and thus to enable the brushite crystals to be classified.

It should also be mentioned that if a single-stage process is to take place, fluidized bed reactor 332 can be used.

1. A method for recovering phosphorus from sludge in sewage plants, wherein the sludge is pre-acidified under anaerobic process conditions and the pH value is then increased to a pH value <7 by adding at least one alkaline calcium-containing chemical, brushite crystals are formed by calcium ions of the chemical and are precipitated, and deposited brushite crystals are removed and the phosphorus-reduced sludge is then supplied to a digestion process, characterized in that
the sludge is dewatered after the digestion process and at least part of the filtrate obtained in this way is supplied to the pre-acidified sewage sludge.

2. The method according to claim 1,
characterized in that
the pre-acidification is carried out by enzymatically induced hydrolysis and fermentation down to low molecular weight organic acids.

3. The method according to claim 1,
characterized in that
the sludge for pre-acidification is subjected to a temperature between 5° C. and 75° C. for a period of between 1 and 7 days under anaerobic process conditions, wherein the sludge can be pre-acidified cold or warm.

4. The method according to claim 1,
characterized in that,
before the pre-acidification, the sludge is optionally disintegrated, in particular mechanically, thermally, thermo-chemically, thermally with pressure, or by the action of ultrasound, in particular using excess sludge or a mixture of excess sludge and externally supplied organic substrates and/or primary sludge.

5. The method according to claim 1,
characterized in that
the pre-acidified sludge is supplied to a phosphorus recovery system (10, 300), in which the sludge is raised to the pH value <7, preferably 6≤pH<7, preferably 6.3≤pH≤6.7, in particular pH approximately=6.5, by supplying the alkaline calcium-containing chemical, in particular a calcium solution such as calcium hydroxide, and deposited brushite crystals are removed.

6. The method according to claim 1,
characterized in that
the sludge is supplied to a reaction vessel (32, 332) of the phosphorus recovery system (10, 300), in which the sludge is circulated with mechanical or hydrodynamic force and/or supported by aeration.

7. The method according to claim 1,
characterized in that
said recovery is carried out in several stages, preferably in two stages, and in the phosphorus recovery system (10, 300) having a first and a second reaction vessel (32, 34, 332).

8. The method according to claim 1,
characterized in that
the calcium-containing chemical is supplied to the sludge present in the first reaction vessel (32, 332).

9. The method according to claim 1, characterized in that
the sludge from the first reaction vessel (32, 332) is supplied to the second reaction vessel (34) via a line (36), in which second reaction vessel (34) an anaerobic environment is set for phosphate redissolution, and in that brushite crystals crystallized out in the second reaction vessel are supplied to the first reaction vessel.

10. The method according to claim 1,
characterized in that
sludge from the second reaction vessel (34) is optionally supplied to a separator (64), in which brushite crystals are separated, which are supplied to the first reaction vessel (32, 332) and/or the second reaction vessel (34).

11. The method according to claim 1,
characterized in that
the sludge supplied to the first reaction vessel (32, 332) from the second reaction vessel (34) is removed from a cone or funnel-shaped lower region (132) of the second reaction vessel.

12. The method according to claim 1,
characterized in that
at least one aeration system (98) or a stirring unit is arranged within the first reaction vessel (32) for energy input to generate a directed flow profile.

13. The method according to claim 1,
characterized in that
the mixing energy in the first reaction vessel (32) takes place in a cylindrical interior space (96) which is surrounded by a cylindrical exterior region (94) in which sludge flows towards the bottom region of the first reaction vessel.

14. The method according to claim 13,
characterized in that
the alkaline calcium-containing chemical is added to the sludge surface (97), preferably above the cylindrical ring-shaped exterior region (94) of the first reaction vessel (32).

15. The method according to claim 1,
characterized in that
the brushite crystals are classified and separated in a reaction vessel (332), the cross section of which increases gradually or continuously starting from the bottom region (382), with pre-acidified sewage sludge being supplied to the reaction vessel in its bottom region.

16. The method according to claim 15,
characterized in that
calcium-containing reagent mixture and/or the alkaline calcium-containing chemical and/or pH-neutral calcium-containing chemical is supplied to the reaction vessel (332) in its lower region and/or to the pre-acidified sewage sludge.

17. The method according to claim 1,
characterized in that
the alkaline calcium-containing chemical is added directly into the sludge supply (28).

18. The method according to claim 1,
characterized in that
a pH-neutral calcium-containing chemical, preferably calcium chloride, is additionally supplied to the sludge in the phosphorus recovery system (10, 300) if there is an insufficient supply of calcium ions.

19. The method according to claim 1,
characterized in that
the sludge removed from the phosphorus recovery system (10, 300) is supplied to a sludge thickening system (42) in which a gravitational and/or mechanical thickening takes place.

20. The method according to claim 1,
characterized in that
that clear water obtained from the thickening and optionally part of the filtrate obtained from the sludge removed from the digestion process is supplied to a tank of a biological treatment stage of a wastewater treatment plant which has an anaerobic environment.

21. The method according to claim 1,
characterized in that
the filtrate is subjected to an ammonium content reduction.

22. The method according to claim 1,
characterized in that
primary sludge, excess sludge, or a mixture of these from a biological water treatment plant and, optionally, additionally delivered organic substrates and/or delivered sludge such as sewage sludge are used as sludge.
